(19) United States
(12) Patent Application Publication
(10) Pub. No.: US 2005/0185431 A1
(43) Pub. Date: Aug. 25, 2005

(54) DC/DC converter

(75) Inventors: Tamio Shimizu, Kawasaki (JP); Taku Nobiki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/042,351

(22) Filed: Jan. 26, 2005

(30) Foreign Application Priority Data
Feb. 20, 2004 (JP) 2004-043876

(51) Int. Cl. H02M 3/335

(52) U.S. Cl. 363/65

(57) ABSTRACT

A tertiary coil is provided in a DC/DC converter. An electric current is generated in the tertiary coil due to on an alternating-current voltage produced in the tertiary coil. An electrical current supplying circuit supplies the electric current generated in the tertiary coil to a load when supplementary power must be supplied to the load.

### BACKGROUND OF THE INVENTION

1) Field of the Invention

The present invention relates to a DC/DC converter.

2) Description of the Related Art

A conventional DC/DC converter, that monitors an output voltage and regenerates the output voltage in a primary condenser to reduce damage to a power source, is disclosed in Japanese Patent Application Laid-Open Publication No. 2001-103746 (see pages 2-3, and FIG. 1). Further, a conventional technology, in which an excitation current is sent through a secondary coil to cause a magnetic flux density of a choker coil to become smaller when a load increases and an output voltage decreases, is disclosed in Japanese Patent Application Laid-Open Publication No. 2003-189613 (see pages 5-6, and FIG. 1).

A circuit configuration of a conventional DC/DC converter is illustrated in FIG. 5. The output characteristics of this conventional DC/DC converter are illustrated in FIGS. 6A and 6B. FIG. 7 is a diagram of the load characteristics of a power source. These figures are used to explain a conventional DC/DC converter.

As shown in FIG. 5, the conventional DC/DC converter includes a condenser C1 that is connected at both ends to a direct-current (DC) input voltage Vin; a primary coil N1 of a transformer that is connected to one end of a DC input voltage Vin; and a switching transistor TR1 that is connected in tandem to the primary coil. The switching transistor TR1 is a FET (field-effect transistor), for example. The other end of the primary coil N1 is connected to a drain of the switching transistor TR1; and the source of the switching transistor TR1 is connected to the other end of the DC input voltage Vin.

The conventional DC/DC converter also includes a secondary coil N2 of a transformer T; and rectifier diodes D1 and D2 that are connected to the secondary coil N2. A choke coil L1 is used for smoothing; and is connected to a cathode of the diode D1. A condenser C2 is used for smoothing; and is connected between the other end of the choke coil L1 and the other end of the common line. Output voltage Vo is taken out from both ends of the condenser C2. Condensers Co1 to Con are connected in parallel between output lines. There is a load 1 that is connected to an output edge.

Resistors R2 and R3 divide the output voltage Vo. An IC circuit 2 activates a photocoupler PC that receives voltage of the divider point by use of the resistors R2 and R3. The photocoupler PC is configured from a photodiode D3 and a phototransistor TR2. The positive voltage of the output voltage is connected to an anode of the photodiode D3 via a resistor R4; and the photodiode D3 is connected to an IC circuit 2 on the cathode-side of the photodiode D3. The collector and emitter of the phototransistor TR2, that configures the photocoupler PC, are inside a controlling circuit 3. The controlling circuit 3 provides “on” or “off” controlling signals to a gate of the switching transistor TR1 which is a switching FET (field-effect transistor). Operations of a circuit configured in this manner are explained below.

The switching transistor TR1 switches the DC voltage Vin in accordance with the switching pulse provided by the controlling circuit 3. The secondary coil N2 of a transistor T2 generates a high-frequency alternating-current. This high-frequency alternating-current is converted into a DC voltage by the rectifier diodes D1 and D2; and then further converted into smooth DC voltage by smoothing circuits consisting of the choke coil L1 and the condenser C2. This DC voltage becomes an output Vo from the DC/DC converter.

The output voltage Vo is monitored by divider circuits that use the resistors R2 and R3; and the monitored output voltage enters the IC circuit 2. The IC circuit 2 activates, in accordance with the output voltage Vo, the photodiode D3; and, depending on the electrical current that is flowing at that time, the photodiode D3 emits light. This emitted light is conveyed to the phototransistor TR2; and causes an electrical current to flow in the phototransistor TR2. In this manner, the controlling circuit 3 is provided with a controlling signal in accordance with the output voltage Vo. When the output voltage Vo is low, the switching transistor TR1 that receives the output of the controlling circuit 3 is in an “on” state for a longer period of time. But when the output voltage Vo is high, the switching transistor TR1 is in an “on” for a shorter period of time. As a result, the value of the output voltage Vo remains constant due to this PWM (pulse-width modulation) control by the controlling circuit 3.

FIGS. 6A and 6B are diagrams of the output fluctuation characteristics of the conventional DC/DC converter. FIG. 6A is a diagram of a change in an output electrical current and FIG. 6B is a diagram of a fluctuation of an output voltage. For example, the initial output electrical current is lo. At a time t1, the output electrical current rapidly changes from I1 to I2 (as illustrated in FIG. 6A). Concurrently, the output voltage Vo rapidly decreases from Vo1 by an amount of Vd1, as illustrated in FIG. 6B The time period of the decrease, from time t1 until the time when output voltage falls by the amount of Vd1, is a time Td1. Later, the output voltage Vo partially recovers up to a level Vo2. The differences of voltages Vo1 to Vo2 is ΔV, which is in accordance with the characteristics of the power source.

FIG. 7 is a diagram of the load characteristics of a power source. In FIG. 7, the vertical axis is the output voltage Vo, the horizontal axis is a load lo. As the load current lo increases, the output voltage Vo decreases. The output voltage when the load current is lo is I1 is Vo1. The output voltage when the load current is I2 is Vo2. A voltage differential ΔV is generated between Vo1 and Vo2. The differential ΔV of the characteristics of FIGS. 6A and 6B are due to this kind of reason.

Recent electronic devices use mainly the DC/DC converter illustrated in FIG. 5 to increase efficiency, but since the DC/DC converters cannot, from an operating viewpoint, keep pace with high-speed responses of an LSI, there is a large voltage fluctuation when the load suddenly changes and there are problems such as an occurrence of a malfunction of the LSI and the like. An output line in FIG. 5 is connected to large-capacity condensers Co1 to Con to respond to the sudden changes of load. However, there is a problem that taking this type of configuration requires large-capacity condensers, which makes the configuration high-priced and packaging space of the configuration larger.

### SUMMARY OF THE INVENTION

It is an object of the present invention to at least solve the problems in the conventional technology.

A DC/DC converter according to an aspect of the present invention includes a transformer having a primary coil, a secondary coil, and a tertiary coil, wherein a direct-current voltage is input to a primary coil of a transformer, switching of the direct-current voltage is performed to generate an alternating-current voltage in a secondary coil, and an electric current based on the alternating-current voltage is supplied to a load; and an electrical current supplying circuit that supplies to the load an electrical current based on an alternating-current voltage generated in the tertiary coil. The electrical current supplying circuit is configured to supply the electrical current to the load when excessively large power is required by the load.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a DC/DC converter according to an embodiment of the present invention;

FIG. 2 is an exemplary circuit diagram of the DC/DC converter shown in FIG. 1;

FIG. 3 is a flowchart of an operation performed by the DC/DC converter shown in FIG. 1;

FIG. 4A is a diagram of a change in an output electrical current of the DC/DC converter shown in FIG. 1;

FIG. 4B is a diagram of a fluctuation of an output voltage of the DC/DC converter shown in FIG. 1;

FIG. 5 is a circuit diagram of a conventional DC/DC converter;

FIG. 6A is a diagram of a change in an output electrical current of the conventional DC/DC converter shown in FIG. 5;

FIG. 6B is a diagram of a fluctuation of an output voltage of the conventional DC/DC converter shown in FIG. 5; and

FIG. 7 is a diagram of load characteristics of a power source.

### DETAILED DESCRIPTION

Exemplary embodiments of a DC/DC converter according to the present invention are explained below in reference to the accompanying drawings.

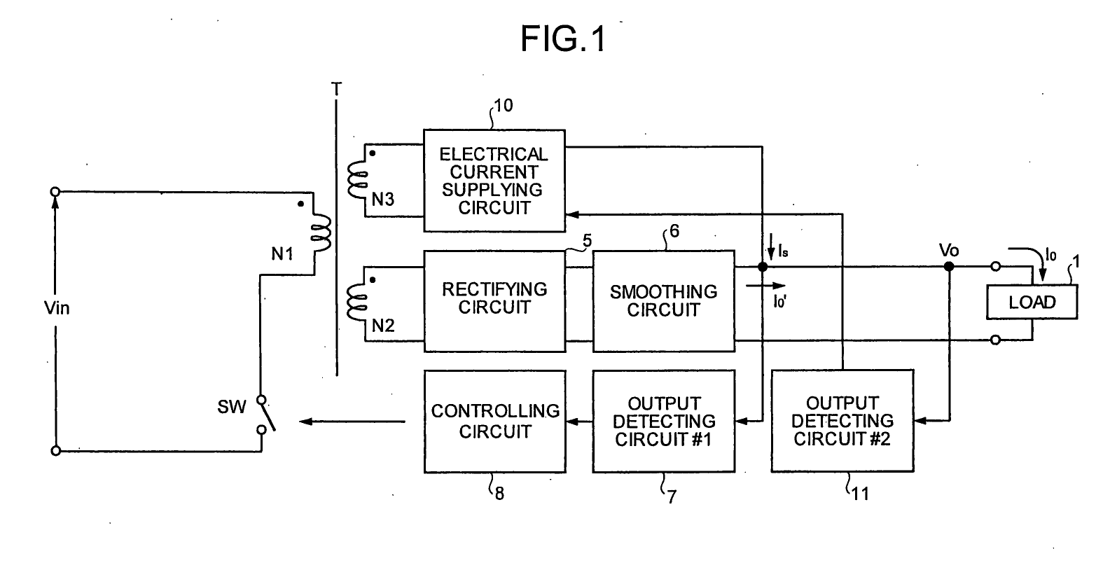

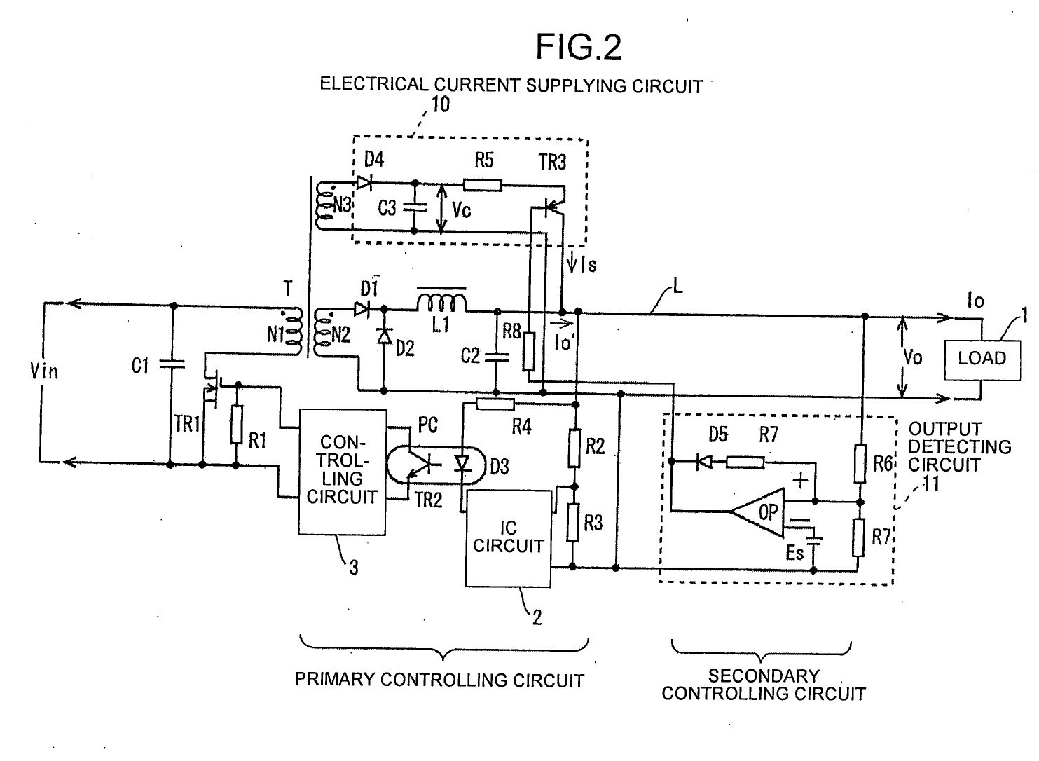

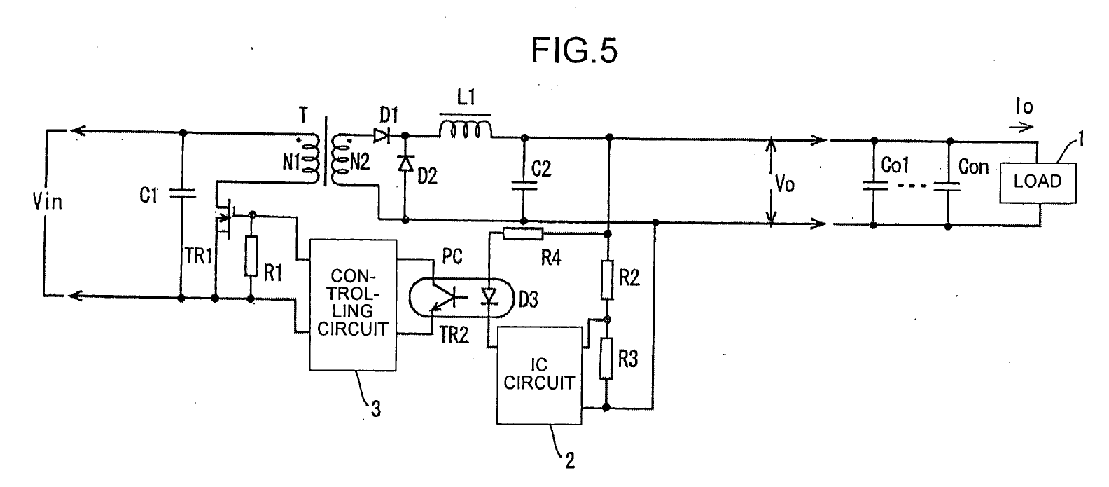

FIG. 1 is a block diagram of a DC/DC converter according to an embodiment of the present invention. FIG. 2 is an exemplary circuit diaagram of the DC/DC converter shown in FIG. 1. In the figures, dentical items have been provided with identical reference numerals. In the figures, a configuration, in which an input of a direct-current voltage Vin, a rectification and a smoothing of an alternating-current voltage induced in a secondary coil N2 of a transformer T to acquire a direct-current voltage, and a PWM control of a primary switching transistor TR1 to stabilize the acquired direct-current voltage Vo are performed, is completely identical to the conventional circuit illustrated in FIG. 5.

In other words, the output voltage Vo is monitored by a divided resistance from resistors R2 and R3, this monitored voltage is input to an IC circuit, and a photodiode D3 of a photocoupler PC is activated by a signal in accordance with the monitored voltage. This electrical current activates a controlling circuit 3, which controls a time that a switching transistor TR1 is “on”. As a result, when the output voltage Vo decreases, the time that the switching transistor TR1 is “on” is lengthened; and when the output voltage Vo increases, the time that the switching transistor TR1 is “on” is shortened. This PWM control keeps the output voltage Vo constant.

An electrical current supplying circuit 10 supplies electrical current, as the need arises, to a power line L; and is the circuit that characterizes the present invention. An output detecting circuit #2 11 monitors the output voltage Vo. The electrical current supplying circuit is controlled in accordance with the detection results of this output detecting circuit #2 11 to supplement the electrical current supplied to the load 1. In the electrical current supplying circuit 10, there is a tertiary coil N3 of the transformer T, a rectifying diode D4 which is connected to the tertiary coil N3, and a smoothing condenser C3 that is connected to a cathode of the rectifying diode D4. An output of a rectifying circuit 5 and a smoothing circuit 6 that are configured from the rectifying diode D4 and the smoothing condenser C3 is Vc. This voltage Vc is connected to an emitter of an electrical current supplying transistor TR3 via a resistor R5. The collector of the electrical current supplying transistor TR3 is connected to the power line L.

In the output detecting circuit #2 11, there are resistors R6 and R7 that monitor electrical output voltages. There is an electrical potential at the divider point between these resistors R6 and R7 which are connected to a positive (+) input of an operational amplifier OP. A tandem circuit of a diode D5 and a resistor R7 is connected between the positive input of the operational amplifier OP and the output to configure a recovery circuit. The output of the output detecting circuit #2 11 is connected to a base of the electrical current supplying transistor TR3 via a resistor R8. A reference voltage Es is impressed on the negative (−) input of the operational amplifier OP.

There is a primary controlling circuit that controls the output circuit of the output voltage Vo; and a secondary controlling circuit that controls the electrical current supplying circuit 10. The correspondences between FIG. 1 and FIG. 2 are as follows. The rectifying circuit 5 of FIG. 1 corresponds to the circuit formed by diodes D1 and D2 of FIG. 2. The smoothing circuit 6 of FIG. 1 corresponds to the circuit of a choke coil L1 and a condenser C2 of FIG. 2. The output detecting circuit #1 7 of FIG. 1 corresponds to the circuit formed from the resistors R2, R3, and R4, the photocoupler PC, and the IC circuit IC. The controlling circuit 8 of FIG. 1 corresponds to the controlling circuit 3 of FIG. 2. The following is an explanation of operations of circuits configured in this manner.

The main power supplying circuit supplies power to the load 1 by use of the stabilizing operations previously described. When the output voltage Vo is held at a predetermined value, the output detecting circuit #2 11 does not operate. In other words, when the output voltage Vo is a predetermined value, the electrical potential of the divider point between the resistors R6 and R7 is higher than the reference voltage Es. Accordingly, the output of the operational amplifier OP becomes positive, and the reverse bias of the electrical current supplying transistor TR3 of the electrical current supplying circuit 10 is maintained. Therefore, a supplementary electrical current Is does not flow.

If the load 1 drastically changes and the output voltage Vo decreases, this change is detected by the output detecting circuit #2 11. Then, the electrical potential at the divider point between the resistors R6 and R7 becomes lower, and the difference between the electrical potential and the reference voltage Es, which the operational amplifier OP outputs, decreases. As a result, the electrical current in the electrical current supplying transistor TR3 receives a forward bias; and electrical current flows in the electrical current supplying transistor TR3. This flowing electrical current is Is, which supplements the load current that flows to the load 1 through the power line L. In other words, when there is an output electrical current lo from the main power circuit, lo′=lo when electrical current is not supplied from the electrical current supplying circuit 10. But if the load 1 suddenly changes and an excessively large electrical current is needed, lo′+ls=lo, and the supplementary electrical current Is from the electrical current supplying circuit 10 becomes a portion of the load current and flows to the load 1.

In this manner, by mean of the present invention, large-capacity condensers are not equipped on the power line L, and it is possible to respond to changes in the load.

Also, by means of the present invention, it is possible to perform stabilization control of the output voltage at the primary controlling circuit; and to perform electrical current supplying control when the load suddenly changes.

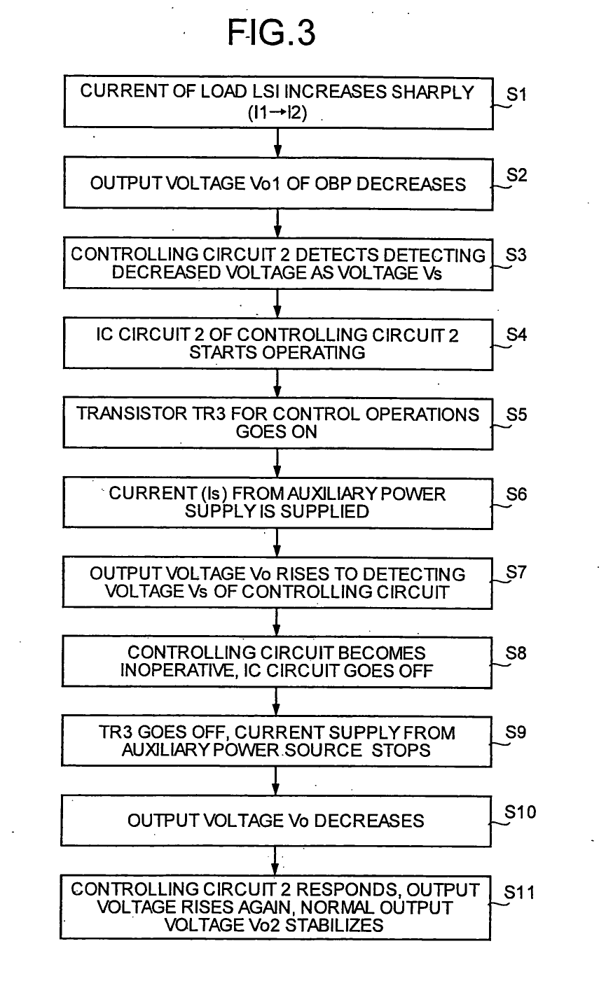

FIG. 3 is a diagram that illustrates an operational flow of the present invention.

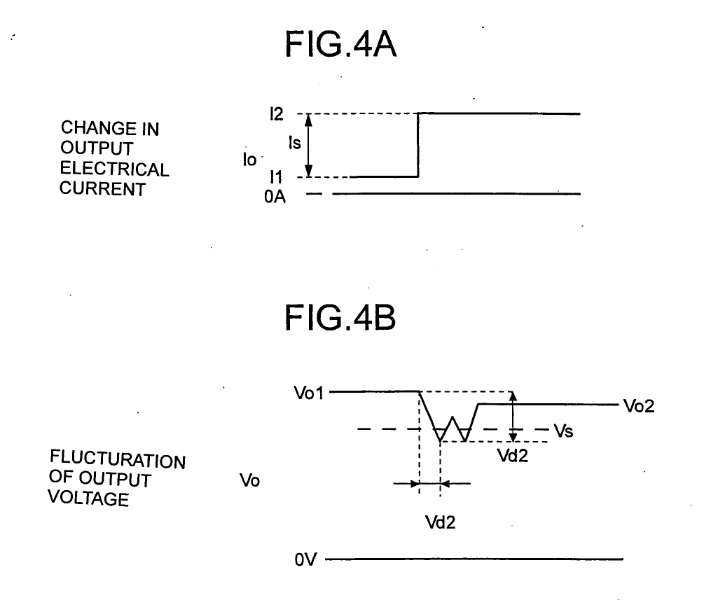

FIG. 4A is a diagram of a change in an output electrical current of a circuit according to the present invention.

FIG. 4B is a diagram of a fluctuation of an output voltage of a circuit according to the present invention.

An explanation is given below while comparing FIG. 3, FIG. 4A, and FIG. 4B. First, the electrical current of an LSI, which is a load, suddenly increases (I1→I2) as illustrated in FIG. 4A (step S1). As a result, the output voltage Vo1 of an OBP (on-board power source) decreases, as illustrated in FIG. 4B (step S2). This decrease of voltage is detected by a secondary controlling circuit (refer to FIG. 2) (step S3). The detected voltage is Vs. The secondary controlling circuit of the operational amplifier OP starts operations (step S4). As a result, the electrical current supplying transistor TR3 of the electrical current supplying circuit 10 goes “on”.

When the electrical current supplying transistor TR3 goes “on”, the supplementary electrical current Is is supplied from the supplementary power source (electrical current supplying circuit 10) (step S6). Concurrently, the output voltage Vo rises until the detected voltage Vs of the secondary controlling circuit (step S7). When the output voltage Vo rises, the secondary controlling circuit becomes inactive, and the operational amplifier OP becomes “off” (step S8). Then, the electrical current supplying transistor TR3 becomes “off”; and the electrical current supply from the supplementary power source (electrical current supplying circuit 10) stops (step S9). Next, when the output voltage Vo decreases (step S10), the secondary controlling circuit responds, and output voltage rises again and becomes a normal output voltage Vo2 that is stable (step S11).

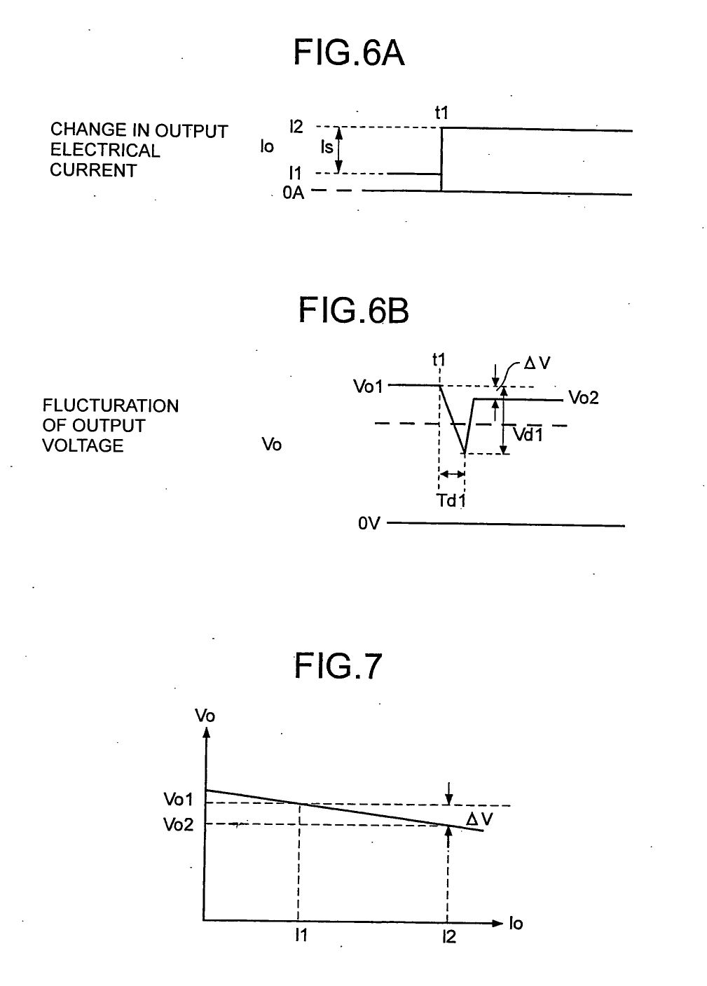

In FIG. 4B, the decreased portion Vd2 of the output voltage becomes a value far smaller that the decreased portion Vd1 of the output voltage of the conventional circuit illustrated in FIG. 6A. Moreover, the time of the decreased output voltage Td2 is also shorter than the time of the decreased output voltage Td1 of the conventional circuit illustrated in FIG. 6A. Further, in FIG. 4B and FIG. 6A, the hunting (surging) of the output voltage with Vs as the center is based on the transient state.

The present invention has an effect of detecting a decrease of output voltage to a load, and making an electrical current supplying circuit quickly supply a supplementary current to the load. Therefore, a capacity condenser for supplementary charge storage, which has a high price and consumes much package space, is not required.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A DC/DC converter comprising:
a transformer having a primary coil, a secondary coil, and a tertiary coil, wherein a direct-current voltage is input to a primary coil of a transformer, switching of the direct-current voltage is performed to generate an alternating-current voltage in a secondary coil, and an electric current based on the alternating-current voltage is supplied to a load; and
an electrical current supplying circuit that supplies to the load an electrical current based on an alternating-current voltage generated in the tertiary coil, wherein
the electrical current supplying circuit is configured to supply the electrical current to the load when excessively large power is required by the load.

2. The DC/DC converter according to claim 1, further comprising:
a first controlling circuit that
detects an output voltage of the DC/DC converter, and
performs pulse-width modulation control of switching elements that switch the direct-current voltage based on the output voltage detected; and
a second controlling circuit that
detects the output voltage of the DC/DC converter, and
provides a controlling signal to the electrical current supplying circuit based on the output voltage detected.

3. The DC/DC converter according to claim 2, wherein the second controlling circuit, upon the output voltage detected indicating an excessive load, provides the controlling signal to the electrical current supplying circuit whereby a required electrical current is supplied to the load.

4. The DC/DC converter according to claim 3, wherein the electrical current supplying circuit includes a transistor circuit, and
the electrical current supplying circuit supplies the electrical current to the load from the transistor when the controlling signal is output from the second controlling circuit.
